(19) United States
(12) Patent Application Publication
(10) Pub. No.: US 2006/0159545 A1
(43) Pub. Date: Jul. 20, 2006

(54) Function carrier for a metal or plastic plate component

(76) Inventors: Richard Humpert, Weilrod (DE); Jiri Babej, Lich (DE)

Correspondence Address: HUNTON & WILLIAMS/NEW YORK, INTELLECTUAL PROPERTY DEPT., 1900 K STREET, N.W., SUITE 1200, WASHINGTON, DC, 20006-1109, US

(21) Appl. No.: 11/374,844

(22) Filed: Mar. 14, 2006

Related U.S. Application Data
(62) Division of application No. 09/890,203, filed on Oct. 5, 2001.

(30) Foreign Application Priority Data
Feb. 8, 1999 (DE) 199 05 041.4

(51) Int. Cl. F16B 37/04

(52) U.S. Cl. 411/181

(57) ABSTRACT

The invention relates to a function carrier having a functional element and a rivet sleeve. The function carrier can be inserted into a plate having a hole with an internal diameter in the plate. A head part has an external diameter corresponding to the hole internal diameter. The element has a shaft part having an axial direction and a rounded concave fillet in a region between the shaft and head parts. The rivet sleeve has a deformable region adjacent the head part and a ring region remote from the head part and has an external diameter greater than the internal diameter. The rivet sleeve is axially movable along the shaft part and the tubular deformable region over the fillet to deform the tubular region radially outwardly to a maximum diameter greater than the external diameter to form a groove between the radially outwardly deformed region and the ring region.

### CROSS REFERENCE TO RELATED APPLICATIONS

This application is a divisional application of U.S. patent application Ser. No. 09/890,203 filed Oct. 5, 2001 which claims priority of PCT/EP00/00271 filed Jan. 14, 2000 which claims priority of German Patent Application No. 199 05 041.4 filed on Feb. 8, 1999.

### FIELD OF INVENTION

The present invention relates to a function carrier which can be inserted from one side into a component, for example into a sheet metal part or into a plastic part, comprising a functional element having shaft and head parts and a rivet sleeve as well as to a component assembly comprising a component with such a function carrier and to a method and tool for the insertion of such a function carrier.

### BACKGROUND OF THE INVENTION

With respect to the prior art, reference is made to the brochure “Nietsysteme-Verbindungen mit Zukunft” (rivet systems—connection with a future) by W. Clemens and O. Hahn, issued by the Association of Publishers: Interessengemeinschaft Formtechnisches Fügen und Laboratorium für Werkstoff- und Fügetechnik der Universität Paderborn, 1. Edition 1994.

This brochure gives a detailed review of various rivet systems including the following:

1. blind rivets

2. lock ring bolts

3. blind rivet nuts and blind rivet bolts

4. rivet nuts and rivet bolts.

As is generally known, a blind rivet comprises a rivet sleeve which is pro vided with a draw pin. The rivet is insertable from one side into a drilled hole, which normally extends through two plate-like components, customarily sheet metal parts which are to be riveted together. They are used from one side with a suitable tool. By exerting a draw movement onto the pin, the head part of the pin brings about a broadening of the rivet sleeve at the side of the two-sheet metal parts remote from the tool, whereby the rivet sleeve is deformed and simultaneously brings about a firm pressing together of the two workpieces that are to be connected. On achieving a predetermined axial stress, the pin breaks at a point of intended fracture, normally in the region of the head part. The two plate-like components are permanently held together by an essentially tubular blind rivet, the two ends of which project radially beyond the drilled hole.

This is a pure rivet connection with in principle the function of holding the two plate-like components against one another.

So-called locking ring bolts consist of a bolt-like element with a head part and a shaft part and a locking ring which is movable over the shaft part of the bolt in the axial direction.

Such lock ring bolts also serve for the connection of, for example, two plate-like components, for which purpose—after the production of a drilled hole which passes through the two components—the bolt element is passed from one side through the two plate-like components to be connected. The locking ring is placed from the other side of the plate-like components over the shaft part of the bolt element and is pressed with a setting tool, on the one hand, in the direction towards the head part of the bolt element, with the two plate-like components being simultaneously pressed against one another and, on the other hand, is plastically de formed radially inwardly, so that the locking ring enters into form-fitted connection with circular grooves on the shaft part of the bolt. The shaft part is drawn at the same time as the locking ring is pressed in the direction towards the head part of the bolt. The setting movement has then been completed when the shaft part breaks at a point of intended fracture, which is normally arranged directly at the end face of the locking ring re mote from the head part of the bolt. A permanent riveted connection also arises here. The locking ring bolt has no function which goes beyond this.

The so-called blind rivet nuts and blind rivet bolts are thread carriers which fulfill the function of a blind rivet and of a nut or of a bolt. They consist either of a rivet sleeve which is provided in the axial region with a nut thread or of a rivet sleeve which is connected in one region in form-fitted manner to a shaft part having a screw thread. The rivet sleeve is screwed onto a pulling mandrel and inserted from one side into a drilled hole. By pulling the pulling mandrel, a thread-free part of the blind rivet nut is up set radially, so that the sleeve is firmly riveted in one or more plate-like components. The pulling mandrel is subsequently screwed out of the blind rivet. A bolt element can now be screwed into the threaded part of the blind rivet nut, whereby another component can be attached to the plate like component or to the plate-like components to which the blind rivet nut is riveted. With a blind rivet bolt, the shaft part of the blind rivet bolt provided with a thread, i.e. the bolt part, serves as the drawing mandrel. Such blind rivet nuts and bolts have the advantage that they can be inserted from one side and not only have a riveting function, but also serve as a function carrier. It is, however, problematic that the strength classification of the connection is restricted since, in a blind rivet nut the thread is provided in the rivet sleeve. The latter must be axially deformable in order to permit the rivet connection to be made. In a blind rivet bolt, the bolt part must be connected to the deformable rivet sleeve. The strength of this connection is ultimately the determining factor for the strength of the total connection. Thus, in both cases, the strength of the deformable rivet sleeve in principle determines the resulting strength of the connection to a further component.

Rivet nuts and bolts are fastener elements which are normally riveted to a plate-like component and are either realized as rivet nuts with an internal thread for the attachment of a further component by means of a bolt element, or as a bolt element with an external thread for the attachment of a further component by means of a nut. Rivet nuts and rivet bolts make it possible to achieve high-strength connections, on the precondition, how ever, that the plate-like component is accessible from both sides, since the setting of rivet nuts and rivet bolts makes it necessary to use a die on one side of the sheet metal part and a plunger on the other side of the sheet metal part.

Rivet nuts and rivet bolts are frequently inserted into sheet metal parts at the same time as the sheet metal parts are shaped in a press. The Sheet metal parts are then frequently assembled or welded into box-like components, for example into the sills, doors or pillars of a motorcar body.

Should, in the course of time, or as a result of a repair, the connection between the rivet nut and the sheet metal part or the rivet bolt and the sheet metal part fail or need replacing, then this proves to be difficult, since one no longer has access to the two sides of the corresponding sheet metal part. The use of a nut or bolt element which is to be welded into place is frequently not possible or not permissible, for example with aluminum bodies or with high-strength sheet metal parts or with co-called composite sheet metal parts with plastic membranes. For such applications, there is therefore the need for a function carrier which can be attached from one side, for example a nut element or a bolt element, which permits a high quality, high-strength connection, i.e. a function carrier which combines the advantages of insertability of blind rivet nuts and blind rivet bolts from one side with the high-strength connection characteristics of rivet nuts and rivet bolts.

Furthermore, there are tasks which cannot be solved or cannot always be satisfactorily solved with the known rivet elements, for example the insertion of function carriers in blind drilled holes in plastic panels or particle boards.

It is thus the object of the present invention to provide a function carrier which, on the one hand, can be inserted from one side and, on the other hand, also enables high-strength connections, with the function carrier being able to serve both as a repair solution in the building of vehicle bodies and elsewhere and, on the other hand, can serve as a novel rivet system with the use in a blind drilled hole also preferably being possible. In addition, the function carrier should be capable of being inserted with forces which can be applied by relatively small tools, so that the insertion is possible even in regions with cramped spatial conditions.

Furthermore, the provision of a method and a tool for inserting a corresponding function carrier belongs to the object of the invention.

### SUMMARY OF THE INVENTION

In order to satisfy this object a function carrier in accordance with the invention is characterized in that the rivet sleeve is movable in the axial direction of the shaft part along the shaft part and in that the functional element has, in the transition region between the shaft part and the head part, a concave fillet forming a sliding surface for the deformation of the rivet sleeve.

The deformation of the rivet sleeve is to be understood here in accordance with the invention in the sense of a radial deflection of the end of the rivet sleeve adjacent to the head part.

Through this design of a function carrier in accordance with the invention the outer diameter of the head part of the functional element and of the tubular region of the rivet sleeve is so selected that it at least substantially corresponds to the internal diameter of a drilled hole in the corresponding plate-like component or is preferably slightly smaller than this, so that the function carrier comprising the functional element and the rivet sleeve can be inserted from one side into the drilled hole. Thereafter, the rivet sleeve is deformed radially outwardly by axial movement of the rivet sleeve along the shaft part of the functional element and by the deformation of the rivet sleeve at the concave fillet, so that a diameter increase of the rivet sleeve occurs and the rivet sleeve then takes care of the required anchoring of the function carrier to or in the plate-like component.

If the function carrier is inserted into a blind drilled hole, then the end of the tubular region of the rivet sleeve is deformed radially beyond the diameter of the head part and engages into the wall of the component, whereby the function carrier can no longer be drawn out of the blind drilled hole. The movement of the function carrier in the other direction, i.e. further into the drilled hole, is moreover prevented in that the head part abuts against the end of the blind hole. The component can be a solid component of plastic, which is present in the form of a thick plate or, for example, in the form of a solid part or of an injection-moulded piece, or in the form of an otherwise shaped part. The component could also consist of other materials, for example of particleboard material.

In a plate-like component with a drilled hole passing through it, the de formable region of the rivet sleeve contacts the side of the component remote from the entry side after deformation and prevents the function carrier being pulled out of the plate-like component again from the entry side. Through the radially outwardly directed deformation of the rivet sleeve the function carrier can be clamped against the wall of the drilled hole. This is, however, in most cases not sufficient in order to prevent an axial movement of the function carrier further through the plate-like component. In order to obtain this function, the rivet sleeve is preferably deformed radially outwardly at its end remote from the head part of the functional element, so that the rivet sleeve ultimately forms a ring-like groove in which the plate-like component or a ring-like bead within the drilled hole is fixedly retained in form-locked manner. As an alternative, the end of the rivet sleeve remote from the head part of the functional element could have a flange part which has a diameter which is greater than that of the drilled hole. In this manner the plate-like component is received in form-locked manner in a ring-like groove between the deformed tubular region of the rivet sleeve and the flange part.

A decisive advantage of the function carrier of the invention lies in the fact that when using a functional element in the form of a fastener element the strength classification of the function carrier is determined by the material processing of the functional element, i.e. its shaft and head part, not by the rivet sleeve, particularly since the shaft part and the head part of the functional element are permanently connected together. The rivet sleeve can in turn be so designed that it is itself straightforwardly able, as a result of the form-locked connection to the plate-like component and/or to the functional element, to transmit axial forces corresponding to the strength classification without failing.

When the functional element is a fastener element this can be realized either as a nut element or a bolt element. In the first case, the functional element is of hollow design, with the thread being realized as an internal thread in the head part and/or in the shaft part. In the case of a bolt element the shaft part is provided with an external thread.

For use in a blind drilled hole in particular, the rivet sleeve has a tubular deformable region adjacent to the head part and a ring-like at least substantially non-deformable region remote from the head part. If, in contrast, the functional element is inserted into a through going drilled hole, then the rivet sleeve preferably consists of a tubular deformable region adjacent the head part and a ring-like deformable region remote from the head part. The end face of the rivet sleeve remote from the head part, i.e. of the ring-like region, is preferably arranged perpendicular to the longitudinal axis of the shaft part and thus forms a surface on which axial forces can be exerted in order to move the rivet sleeve along the shaft part and to bring about the desired radially outwardly directed deformation of the rivet sleeve at the concave fillet. The said end face of the rivet sleeve is formed in a preferred embodiment as a sliding surface and can then be pushed in the axial direction by means of a part which is rotated to produce the axial movement of the rivet sleeve in the direction towards the head part of the functional element.

For example, a nut element could be screwed onto the shaft part of the functional element which is provided with an external thread and through the rotation of the nut element a corresponding axial force can be exerted onto the rivet sleeve. In order to prevent co-rotation of the rivet sleeve, noses or grooves extending in the longitudinal direction of the functional element can be provided in the region of the concave fillet.

It is, however, also possible to provide the rivet sleeve itself with an internal thread in the region remote from the head part of the functional element and to thereby move the rivet sleeve itself in the direction of the head part so that it is rotated on a corresponding external thread on the shaft part of the functional element, at least in the region adjacent to the con cave fillet. In this case, the end face of the rivet sleeve remote from the head part is designed to pick up torques which rotate the rivet sleeve and bring about the deformation of the rivet sleeve.

In order to avoid a simultaneous rotational movement of the functional element as a result of friction forces, the shaft part of the functional element is preferably provided at the end remote from the head part with a means for transmitting torques. This means can be a spigot having a plurality of side faces or longitudinal grooves can, however, also have the form of a socket head screw recess formed in the free end of the shaft part, for example in the form of an internal hexagon.

In a particularly preferred embodiment, the shaft part of the functional element has a ring groove, at least in the region directly ahead of the con cave fillet, with the ring-like region of the rivet sleeve being deformable into this ring groove.

In a further preferred embodiment the ring-like region of the rivet sleeve has at least substantially the shape of a right-angled triangle considered in a radial section, with the outer side arranged obliquely to the end face of the rivet sleeve remote from the head part and to the inner face of the rivet sleeve adjacent the shaft part. This design is so contrived that the maximum diameter of the rivet sleeve is somewhat larger than the diameter of the drilled hole of the plate-like component, so that the inclined surface of the right-angled triangle contacts the ring-like edge of the drilled hole in the plate-like component and, during the deformation of the rivet sleeve, leads to a deformation of the wall of the drilled hole, so that a ring bead is formed which comes to lie in a ring groove-like recess of the rivet sleeve, which is formed during the radially outwardly directed deformation of the region of the rivet sleeve adjacent the functional element between this region and the inclined surface of the ring-like region of the rivet sleeve.

Particularly preferred embodiments of the function carrier can be seen from the further subordinate claims.

If a function carrier is inserted into a blind drilled hole in a plate-like component then, in accordance with the invention, a component assembly arises in accordance with claim 20. If a function carrier, in accordance with the invention, is inserted into a plate-like component with a through-going drilled hole, then a component assembly arises in accordance with claim 21.

A method in accordance with the invention for the insertion of a function carrier in accordance with the invention into a plate-like component is characterized in that the head part of the functional element is passed through a hole formed in the plate-like component or is pressed into a recess formed in the component and the rivet sleeve is subsequently moved in the axial direction of the functional element onto the concave fillet and onto the head part of the functional element, whereby the tubular region of the rivet sleeve is deflected radially outwardly by the concave fillet into an anchoring position in which the free end of the tubular region projects radially beyond the head part of the functional element.

A tool in accordance with the invention for inserting a function carrier in accordance with the invention is preferably characterized in accordance with claim 30.

Further inventive designs of the component assembly, of the method and of the tool can be seen from the further patent claims and also from the subsequent description of preferred embodiments.

### BRIEF DESCRIPTION OF THE FIGURES

The invention will now be explained in more detail in the following with reference to embodiments and to the drawings in which show:

FIG. 1 a side view of a functional element in the form of a bolt element,

FIG. 2 a longitudinal section through a rivet sleeve,

FIG. 3 a plan view of the rivet sleeve of FIG. 2 seen in the arrow direction III,

FIG. 4 a representation corresponding to FIG. 1, but with the rivet sleeve arranged on the functional element in a starting position,

FIG. 5 a plan view of the bolt element of FIG. 1 seen in the arrow direction V,

FIG. 6 the bolt element of FIG. 1 with the rivet sleeve shown in the deformed state in the end position,

FIG. 7 a representation in accordance with FIG. 6, but after insertion of the bolt element with the rivet sleeve into a blind hole of a component, consisting here of plastic,

FIG. 8 a representation o FIG. 7 with a longitudinal cross-section through a tool for the deformation of the rivet sleeve,

FIG. 9 a representation corresponding to FIG. 7, but here with a nut screwed onto the bolt element, the nut being simultaneously able to serve as the tool for the deformation of the rivet sleeve,

FIG. 10 a representation in accordance with FIG. 1, but from a modified embodiment of a bolt element,

FIG. 11 an end view of the bolt element of FIG. 10 seen in the arrow direction XI,

FIG. 12 a partly sectioned perspective representation of another embodiment of a rivet sleeve in accordance with the invention,

FIG. 13 a longitudinal section through the rivet sleeve of FIG. 12 corresponding to the section plane XIII-XIII,

FIG. 14 a plan view of the end face of the rivet sleeve of FIG. 12 seen in the arrow direction XIV,

FIG. 15 a representation of the rivet sleeve of FIG. 12 on the bolt element of FIG. 10 shown in the starting position,

FIG. 16 the combination of FIG. 15 after the deformation of the rivet sleeve in its end position,

FIG. 17 a representation similar to FIG. 7, but using the combination of the functional element and of the rivet sleeve of FIG. 15,

FIG. 18 a representation similar to the representation of FIG. 16, but with the element inserted into a plate-like component in the form of a sheet metal part,

FIG. 19 a schematic representation of a further bolt element and rivet sleeve combination in accordance with the invention, which is in particular designed for use with a sheet metal part,

FIG. 20 a schematic representation of the bolt element and rivet sleeve combination of FIG. 19 in order to show how the insertion takes place into a pre-holed component, and

FIGS. 21,22 illustrations similar to FIGS. 19 and 20, but using a functional element in the form of a nut.

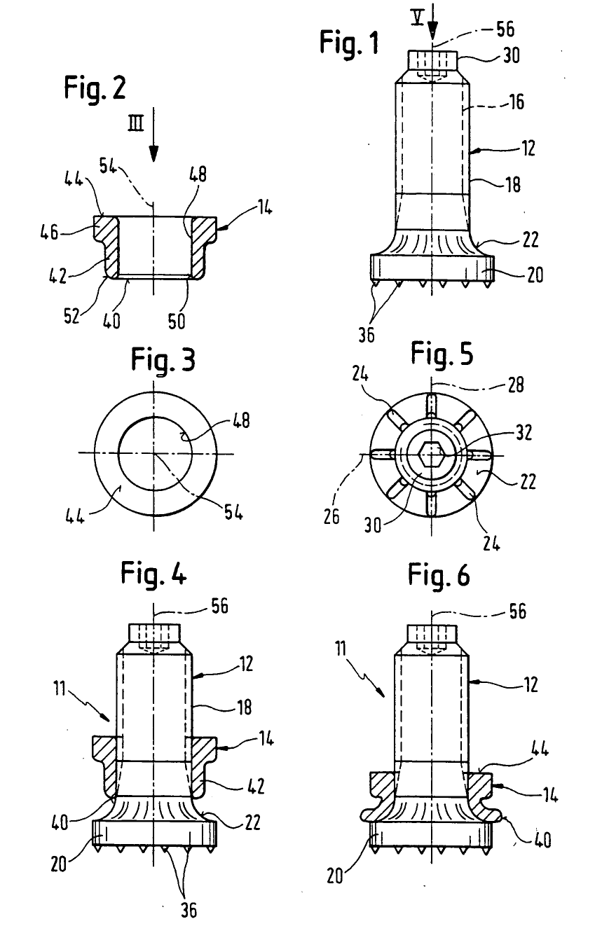

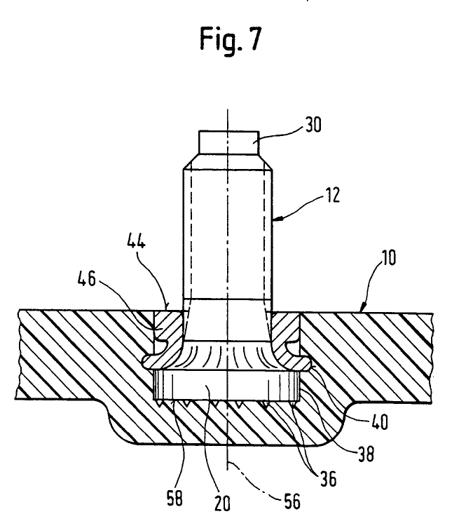

The FIGS. 1 to 7 are concerned with a first embodiment of a function carrier 11 in accordance with the invention which can be inserted from one side into a plastic component 10 (FIG. 7) and which comprises a bolt element 12 and a rivet sleeve 14. The bolt element 12 has a shaft part 18 provided with a thread 16 and has in the transition region between the shaft part 18 and the head part 20 a concave fillet 22 which forms a sliding surface for the deformation of the rivet sleeve. As can be seen from FIG. 5, rounded grooves 24 are worked into the sliding surface and are each arranged in a longitudinal plane of the bolt element 12, for example in the plane 26 or in the transverse plane 28. These rounded recesses are not essential and could be omitted or replaced by bead-like raised features with the same alignment. Combinations of bead-like raised features and groove-like recesses could also be used. These groove-like recesses and/or the corresponding bead-like raised features ensure that a relative rotation of the bolt element and of the rivet sleeve is prevented which, depending on the design of the element, is desirable, as will be explained in the following.

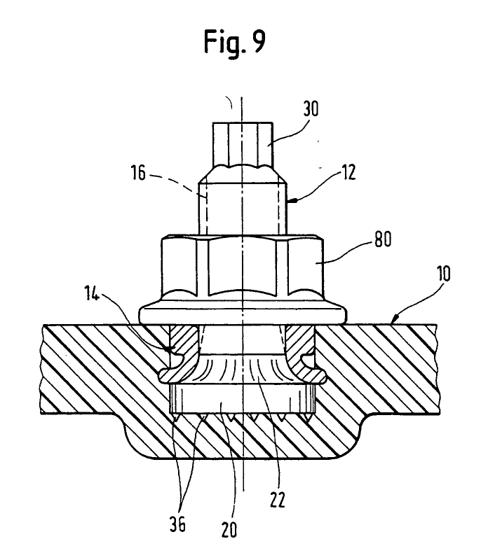

At its end face remote from the head part 20 the bolt element 12 has a spigot 30 which—as can be seen from FIG. 5—contains an internal hexagon in this case and has transverse dimensions which are smaller than the core diameter of the thread. Instead of using an internal hexagon one could also use an external hexagon 30 which is indicated in FIG. 9. In principle, any known wrench-receiving shape could be used, be it in the form of an internal recess or an external mount. The purpose of the selected wrench mount is to enable the bolt element to be held in a manner secured against rotation by a suitable tool during its insertion. For the same purpose, the bolt element 12 of FIG. 1 has, at the end face of the head part 20 remote from the thread 16, a plurality of conical point-like or pyramidal raised features 36 which, on being used in a blind hole 38 in a component 10 in accordance with FIG. 7, engage into the base of the blind hole 38 and likewise provide a contribution to security against rotation.

The rivet sleeve 14 has, in the embodiment of FIGS. 2 and 3, a tubular de formable region 42 at one end 40 and, at the other end 44, an at least substantially non-deformable region 46 which is thicker in comparison to the deformable region 42.

The rivet sleeve 14 has a cylindrical passage 48, the internal diameter of which is slightly larger than the outer diameter of the thread 18, so that the rivet sleeve is admittedly guided over the thread cylinder but is not prevented from moving axially along the thread cylinder 18.

The end face 40 merges via a rounded surface into the cylindrical passage 48. This rounded surface 50 assists the sliding movement of the deform-able section 42 of the rivet sleeve during the deformation at the sliding surface 22. The transition 52 between the end face 40 and the outer side of the deformable section 42 is also gently rounded, in order to facilitate the penetration of the end face of the rivet section into a component.

The end face 44 of the rivet sleeve stands perpendicular to the longitudinal axis 54 of the rivet sleeve and is formed as a sliding surface.

As is readily seen from FIG. 4 the rivet sleeve 14 is placed over the shaft part 16 of the bolt element 12 with its axis 54 coaxial to the longitudinal axis 46 of the bolt element and is pressed downwardly sufficiently far that the end face 40 comes into contact with the head part at the start of the gently rounded transition 22. This represents the starting position of the function carrier of the invention.

If the rivet sleeve 14 is pressed further downwardly, the cylindrical rivet section 42 slides along the sliding surface formed by the transition 22, i.e. along the concave fillet. The end face 40 of the rivet section is increasingly pressed outwardly in the radial direction until the end position of FIG. 6 is achieved, where the deformed end face 40 of the rivet sleeve 14 now projects perpendicular to the longitudinal axis of the functional element 12 and radially beyond the maximum diameter of the head part 20 of the bolt element.

During the corresponding deformation of the cylindrical rivet section the pressure exerted onto the end face 44 also operates in such a way that the cylindrical rivet section 42 is partly pressed into the grooves 24. These grooves 24 then ensure that the rivet sleeve is only displaced in the axial direction, but is not turned relative to the bolt element 12.

FIG. 6 serves for the explanation of the deformation of the rivet sleeve 14.

FIG. 7 shows a first practical realization of the insertion of the function carrier of FIG. 4 into a component 10.

As can be straightforwardly seen from FIG. 7, the blind hole 38 of the plate-like component 10 has an internal diameter which corresponds to the outer diameter of the head part of the bolt element 12. The blind hole 38 is prepared prior to insertion of the bolt element 12 and has a base surface 58 extending perpendicular to the longitudinal axis 56 of the bolt element (at the same time the longitudinal axis of the blind hole). The combination of the bolt element 12 with the rivet sleeve 14 in the starting position of FIG. 4 is inserted into the blind hole in the axial direction and likely pressed into contact so that the conical tips 36 are pressed into the material of the plate-like component, i.e. into the base surface 58 of the blind hole, whereby a security of the bolt element against rotation is achieved in the plate-like component. During the deformation of the rivet sleeve, the previous end face 40 of the ring-like rivet section 42 which is deflected into the radial direction presses into the wall of the blind hole 38 and prevents in the installed state, as is shown in FIG. 7, the bolt element 12 being drawn out of the plate-like component 10 in the axial direction 56.

One notes that in this example the end face 44 of the rivet sleeve lies flush with the surface of the plate-like component. One also notes that the outer diameter of the non-deformable region 46 of the rivet sleeve corresponds to the internal diameter of the blind bore 48.

Several possibilities exist for carrying out the deformation of the rivet sleeve.

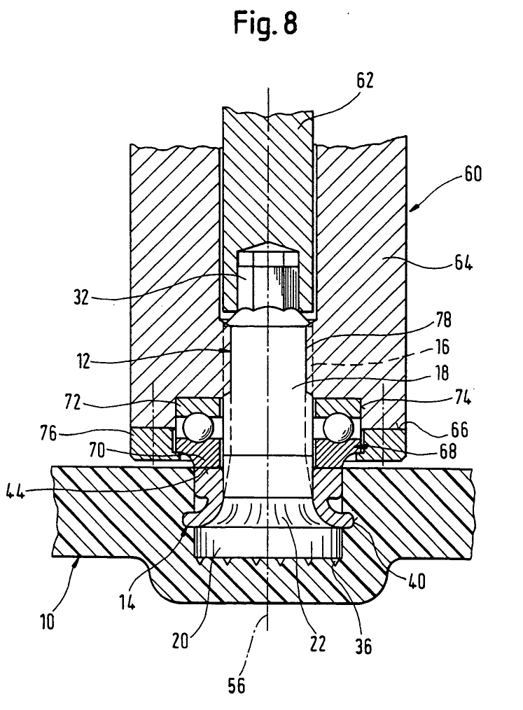

If it were possible to support the plate-like component 10 from below then it would be sufficient to exert a force directed in the direction of the longitudinal axis 56 of the bolt element in a press or the like on the end face 44. In many cases, a support of the plate-like component 10 of this kind is, however, not possible. Then a tool in accordance with FIG. 8 could be used.

In this example, and in all subsequent examples, the same reference numerals are used as are used in connection with the embodiment of FIGS. 1 to 7. It is to be assumed that the previous description in connection with FIGS. 1 to 7 also applies for later embodiments unless something to the contrary is stated.

The tool 60 of FIG. 8 which is used for the insertion of the function carrier consists of two parts arranged coaxial to one another, namely, on the one hand, at the middle, a non-rotatable or fixedly holdable wrench 62 which has at its end confronting the bolt element 12 an internal hexagonal recess which fittingly receives the spigot 30 of the bolt element 12 which is realized as an external hexagon 32 and which prevents a rotation of the bolt element during its insertion. The tool 60 also has a cylindrical sleeve 64 coaxial to the key 64 and the cylindrical sleeve carries at its end face adjacent the component 10 a thrust bearing 68, here in the form of an axial ball bearing, the lower race 70 of which presses against the end face 44 of the rivet sleeve and the upper race 72 of which is arranged in a matching recess 74 in the end face 66 of the rotatable sleeve 64. The thrust bearing 68 is held by a holding ring 76 screwed to the end face 66 of the sleeve 64 by means of screws (not shown) which, on the one hand, prevents the two races 70 and 72 falling apart, but, on the other hand, permits a relative rotation between the race 70 and the sleeve 64.

Directly above the recess 74 for the thrust bearing 68, the sleeve 64 has an internal thread 78 which is designed complementary to the thread cylinder 18 of the bolt element 12. In this manner, a rotation of the sleeve 84 about the longitudinal axis 56 of the bolt element leads to an axial movement of the sleeve with thrust bearings 68 in the direction of the longitudinal axis 56 towards the head part of the bolt element. During this movement, the thrust bearing 68 prevents torques being exerted onto the rivet sleeve 14, so that the danger of rotation between the rivet sleeve 14 and the bolt element 12 does not exist here. Thus, in this embodiment, it is entirely possible to dispense with grooves or beads 64.

During the rotary movement of the sleeve 64 during the insertion of the function carrier, the wrench 62, which is pressed in the axial direction 56 of the tool 60 onto the bolt element 12, ensures the torque exerted by the sleeve via the meshing threads 78 and 18 onto the bolt element does not lead to an actual rotation of the bolt element 12 relative to the plate-like component.

As soon as the end state of FIG. 8 has been reached, the sleeve 64 is turned in the opposite direction in order to release the tool 60 from the bolt element, whereby the end state of FIG. 7 is reached.

As shown in FIG. 9, a nut 80 can then be screwed onto the bolt element 12 and can be utilized for the attachment of another component to the component 10. FIG. 9 shows that the same nut 80, or possibly a special nut 80 with a longer thread cylinder, can also be used for the insertion of the function carrier. For this purpose, the nut 80 is screwed onto the thread cylinder 18 of the bolt element 12 in the state of FIG. 4. Thereafter, the function carrier is inserted into the blind hole. One can then hold the bolt element 12 via the spigot 30 at the outer hexagon that is provided by means of a suitable wrench and can then screw the nut 80 downwardly in order to bring about the deformation of the rivet sleeve.

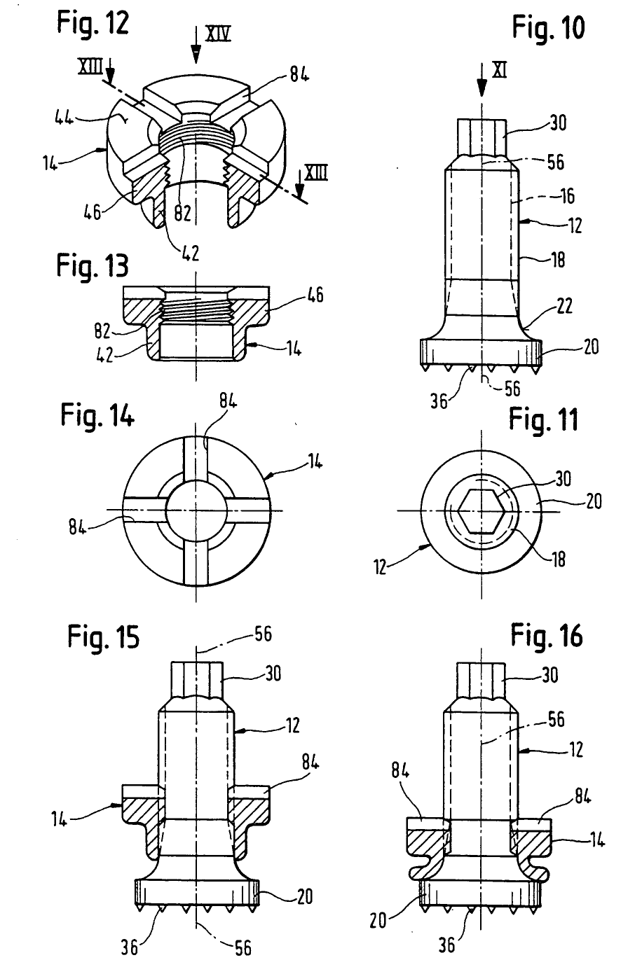

FIG. 10 shows in principle the same bolt element 12 as FIG. 1, only with a somewhat longer spigot, which is better able to prevent a rotation of the bolt element on its insertion. In this embodiment a modified rivet sleeve 14 is used. The rivet sleeve 14 of this embodiment has, as previously, a tubular, cylindrical, deformable section 42 and a ring-like non-deformable section 46. The ring-like non-deformable section 46 has an internal thread 82 which is made complementary to the thread cylinder 18 of the bolt element 12, so that the rivet sleeve itself can be screwed onto the bolt element 12. In order to carry out this screwing on movement, the ring-like region 46 of the rivet sleeve 14 has two drive grooves 84 arranged at right angles to one another in the end face 44. Other form-fitted, tool-engaging elements can also be provided at the non-deformable section 42.

The rivet sleeve is first screwed onto the thread cylinder 18 of the bolt element until the starting position of FIG. 15 is reached. In this state, the head part of the bolt element 12, which is also provided here with conical points 136 is inserted into the blind hole of a component, as for example shown in FIG. 17.

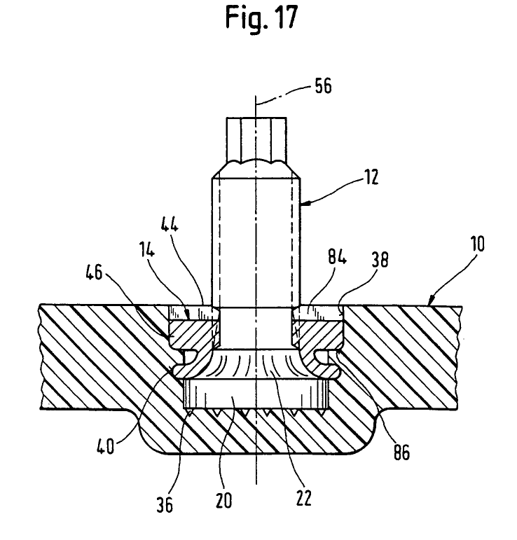

The rivet sleeve 14 can now be screwed further downwardly by means of a tool which engages into the drive grooves 84 in the end face 144 of the rivet sleeve, so that the rivet sleeve 14 is simultaneously turned around the longitudinal axis 56 of the bolt element and moves in the axial direction towards the head part 20 of the bolt element 12. This axial movement also leads to the deformation of the cylindrical rivet section 42 until the state of FIG. 16 is reached. One can see that in this example the rivet sleeve is turned relative to the bolt element. In order to prevent a simultaneously rotation of the bolt element, a tool can be placed onto the spigot 30 as previously. Since, in this example, a relative rotation between the rivet sleeve and the bolt element occurs, the ring-like grooves or beads 24 in accordance with FIG. 5 are missing, as shown in FIG. 11.

FIG. 17 now shows the function carrier in the installed state in a component. The difference to the previous embodiment of FIG. 7 is in this case first of all that the blind hole 38 has an enlarged diameter in the upper region, with this region serving to receive the non-deformable region 46 of the rivet sleeve 14 which is likewise of enlarged diameter. The depth of this region is so selected that the end face 44 of the rivet sleeve lies in the installed state flush with the surface of the component 10. The ring shoulder 86 formed between the two cylinder regions of the blind bore 38 thus ensures a better support of the bolt element 12 relative to the component and offers an additional protection against canting of the bolt element. The somewhat larger diameter of the non-deformable region 46 of the rivet sleeve also offers more reliability that this region of the rivet sleeve is not deformed on applying the torques that are required. The non deformable section 46 of the rivet sleeve can also be formed as a flange which comes to lie on the exposed surface of the component around the drilled hole, i.e. has a corresponding contact surface here.

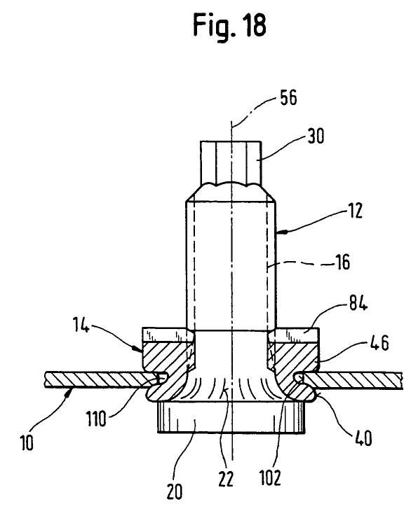

FIG. 18 shows that the function carrier 11 of FIG. 15 can also be used with a sheet metal part or components 10 having a through going hole 102. Here, the edge region of the holed sheet metal part or of the here plate-like component come to lie in the groove 110 formed. between the radially outwardly deformed end 40 of the rivet sleeve and the ring-like region 46 of the rivet sleeve. The security against rotation of the connection is here principally ensured by the clamping that is achieved can, however also be assisted by shape-giving features, for example by recesses in the wall of the hole 102. In this embodiment the tips 36 of FIG. 15 can be omitted.

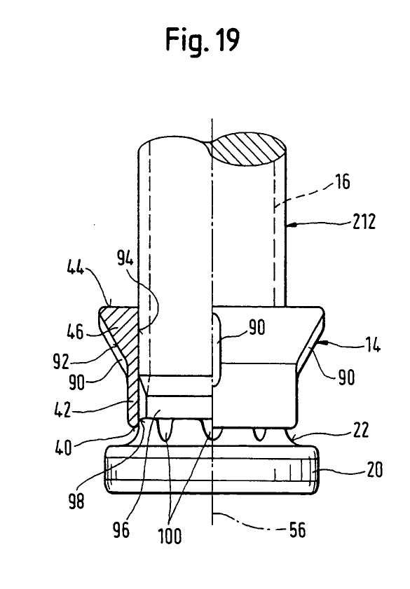

In the embodiment of FIG. 19, both the rivet sleeve 14 and also the functional element 12 are shaped somewhat differently than before. The rivet sleeve 14 is shown in cross-section to the left-hand side of the longitudinal axis of the functional element 12 and can be seen in side view at the right hand side of the longitudinal axis 15. The rivet sleeve 14 also consists here of a cylindrical deformable region 42 and of a second ring-like region 46 which has here an at least substantially triangular cross-section and is in addition deformable. At the outer side of the upper ring-like section 46 of the rivet sleeve 14 of FIG. 19 elongate noses 90 are located on the oblique outer surface which, related to the longitudinal axis 56 of the bolt element 12 or of the rivet sleeve 14, are each arranged in radial planes. One can see here that the ring-like region 46 of the rivet sleeve 14, when considered in the radial section, has at least substantially the shape of a right-angled triangle, the outer side 92 of which is arranged obliquely to the end face 44 of the rivet sleeve 14 remote from the head part 20 and to the inner surface 94 of the rivet sleeve adjacent to the shaft part. This inner surface 94 of the rivet sleeve forms in axial continuation the inner wall of the tubular region of the rivet sleeve. The end face 40 of the rivet sleeve 14 is formed in accordance with the end face 40 of the rivet sleeve of the previous embodiments.

In this embodiment the functional element 12 is formed as a bolt element, as in the other embodiments, and thus has a thread cylinder 16.

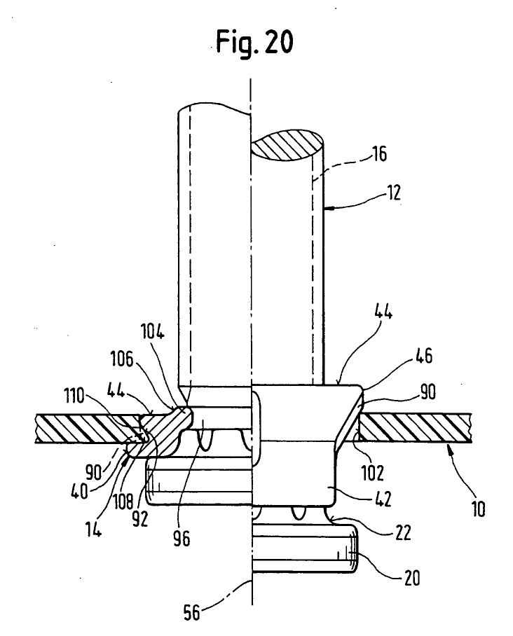

Between the runout end of the thread cylinder 16 adjacent the head part 20 and the sliding surface 22 there is located in this embodiment a ring groove 96, the function of which will be described later with reference to FIG. 20.

This ring groove 96 merges via a rounded ring shoulder 98 into the sliding surface 22. There are, moreover, some rounded recess 100 present in the sliding surface 22 of which eight are arranged at uniform angular intervals round the longitudinal axis 56 in this embodiment.

The installation of this function carrier will now be explained with reference to FIG. 20. This Figure shows at the right-hand side of the central longitudinal axis 56 the starting situation during installation of the function carrier into a plate-like component 10 and, at the left-hand side, the finished installed state. One notes with reference to the right-hand side of the representation in FIG. 20 that a cylindrical hole 102 is provided in the plate-like component 10. The inner diameter of this hole 102 corresponds to the outer diameter of the head 20 of the functional element 12. One notes also that the maximum diameter of the ring-like region 46 of the rivet sleeve is made somewhat larger than the hole 20, so that the rivet sleeve cannot pass through the sheet metal part. Specifically, the rivet sleeve 14 sits with the longitudinal noses 90 on the upper edge of the cylindrical hole 102.

Starting from this state, a downwardly directed force is now exerted onto the surface 44 of the rivet sleeve by means of tool in accordance with FIG. 8 or FIG. 9. At the same time an upwardly directed force is exerted on the shaft part 18 of the bolt element 12. These two forces lead to a deformation of the rivet sleeve 14 so that this achieves the end shape with a cross-section as shown on left-hand side of FIG. 20. That is to say that the tubular cylindrical section 42 of the rivet sleeve slides, as previously, over the sliding surface 22 and is deformed radially outwardly so that the previous end face 40 of the rivet sleeve projects radially beyond the head part 20 of the bolt element 12 and comes to lie on the lower side of the plate like component 10. The ring-like section 46 of the rivet sleeve is likewise deformed in a manner such that a part of it is deformed into a ring-like inwardly directed projection 104 which at least substantially fills out the ring groove 96 of the bolt element 12. This ring-like projection 104 merges via an approximately conical ring shoulder 106 into the remaining end face 44 of the rivet sleeve which lies at least substantially flush with the surface of plate-like component 10 remote from the head part.

During the deformation of the rivet sleeve 14 the oblique surface 92 of the ring-like part 46 leads to a deformation of the wall of the hole 102 50 that this forms an inwardly directed ring projection 108 which comes to lie in a groove 110 formed between the remainder of the oblique surface 92 and the previous outer side of the ring-like section 42, which is now horizon tally directed in FIG. 20. The longitudinal noses 90 of the ring-like region 46 of the rivet sleeve 14 form corresponding dents in the ring-like projection 108. In this way they ensure that the deformed rivet sleeve is also se cured against rotation relative to the plate-like component 10.

The ring-like rivet sleeve 14 is, however, also deformed in such a way that regions of it come to lie in the recesses 100, whereby a rotational security of the functional element 12 with respect to the rivet sleeve is achieved. As the bolt element 12 is secured against rotation relative to the rivet sleeve 14 and the rivet sleeve is secured against rotation relative to the plate-like component 10, the bolt element 12 is also held secured against rotation relative to the plate-like component.

Since the ring projection 104 at least substantially fills out the ring groove 96 and the plate-like component lies in the groove 110 formed by the inclined surface 92 and the deformed ring-like region 42 of the rivet sleeve, the functional element 12 is also fixed relative to the plate-like component in the axial direction.

After the installation of the bolt element 12 in accordance with FIG. 20 a further plate-like component can be secured on the plate-like component 10 by means of a nut screwed onto the thread cylinder 16. This further plate-like component preferably has a hole such that it is centered by the oblique ring shoulder 106. The further plate-like component should, moreover, have a surface extent such that it engages both over the end face 44 of the deformed rivet sleeve 14 and also over a part of the edge of the plate-like component 10 surrounding the hole 102.

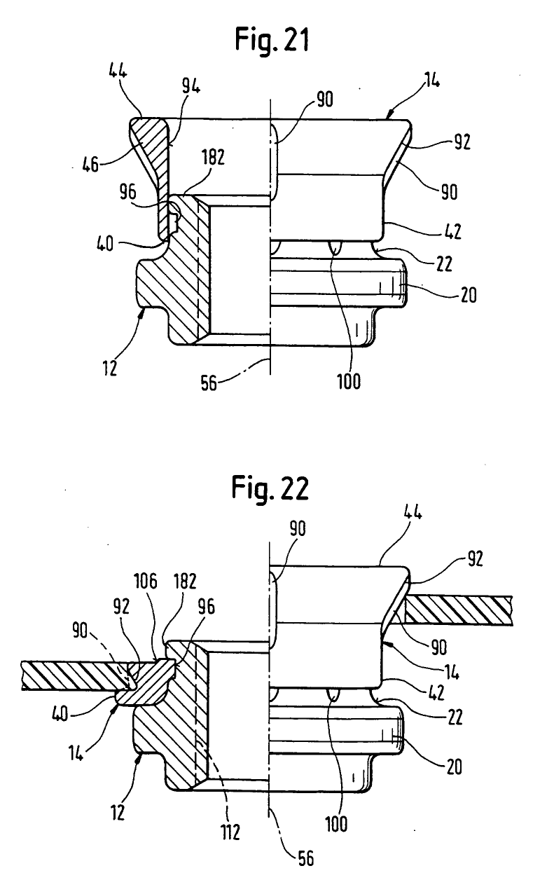

The FIGS. 21, 22 show the representation similar to that of FIGS. 19 and 20 but in which the functional element 12 or the nut element is provided with an internal thread 112. For the insertion of the element a bolt part is screwed into the internal thread 112 and makes it possible to pull the head part 20 upwardly while the rivet sleeve is being pressed downwardly.

The conical surface 106 serves as a centering aid for the further component which is to be screwed in place. The constructional height of the element is minimized, i.e. the shaft part 182 is restricted at least substantially to the transition region 22 to the head part 20. The possibility of realizing the functional element as a nut element exists in principle for all previous embodiments. The possibility also exists of realizing other functions than screw functions. For example, the corresponding functional element can be used as a cylindrical guide spigot or as a snap fastener element for, for example, carpets or the like.

Although the thread 16 of the bolt element can be exploited in the above embodiments for the production of the axial force on the rivet sleeve 14, a preferably hardened sleeve with a fine thread can optionally be brought over the thread 16 of the bolt element and the fine thread can be used for the production of the axial force of the rivet sleeve.

Through the smaller pitch the mechanical advantage can be increased, i.e. greater deformation forces can be applied. An embodiment similar to a hydraulic device would also be conceivable whereby even larger deformation forces could be produced.

It should finally be pointed out that the deformation of the rivet sleeve can also be carried out with a tool which is designed to exert a pulling force onto the shaft part 18 of the functional element away from the head part 20 and at the same time to exert a pressing force onto the end face 44 of the rivet sleeve in the direction towards the head part 20, similar to a customary pair of riveting tongs. This possibility exists for all embodiments of the function carrier of the invention.

1. A function carrier comprising a functional element and a rivet sleeve, said function carrier being adapted for insertion into a metal or plastic plate having a first and a second side and a hole extending from said first side towards said second side, said hole having an internal diameter, said functional element comprising a head part having an external diameter corresponding to said internal diameter, a shaft part having an axial direction and a rounded concave fillet in a transition region between said shaft part and said head part, said rivet sleeve having a tubular deformable region adjacent said head part and a ring region remote from said head part, said ring region having an external diameter greater than said internal diameter and said rivet sleeve being movable in said axial direction along said shaft part and said tubular deformable region over said rounded concave fillet to deform said tubular deformable region radially outwardly to a maximum diameter greater than said external diameter thereby forming a groove between said radially outwardly deformed region and said ring region.

2. A function carrier in accordance with claim 1 and adapted to trap material of said plate in said groove.

3. A function carrier in accordance with claim 1, wherein said ring region or said rivet sleeve is a substantially non-deformable region.

4. A function carrier in accordance with claim 1, wherein said ring region is a deformable region.

5. A function carrier in accordance with claim 1, wherein said rivet sleeve has an end face remote from said head part, said end face being disposed perpendicular to said axial direction.

6. A function carrier in accordance with claim 5, wherein said end face is formed as a sliding surface.

7. A function carrier in accordance with claim 5, wherein said end face is formed for the transmission of rivet forces acting in said axial direction but is not itself deformable or is at least substantially not deformable under the riveting forces.

8. A function carrier in accordance with claim 5, wherein said end face is adapted to take up torques which turn said rivet sleeve and bring about deformation of the rivet sleeve.

9. A function carrier in accordance with claim 8, wherein said shaft part has an outer thread, at least in a region adjacent to said concave fillet and wherein said rivet sleeve has an internal thread corresponding thereto.

10. A function carrier in accordance with claim 1, wherein said shaft part has a means for the transmission of torques at an end remote from said head part.

11. A function carrier in accordance with claim 10, wherein said means is a spigot having one or more side faces or longitudinal grooves.

12. A function carrier in accordance with claim 10, wherein said means has the form of a tool or wrench receiving recess formed in a free end of said shaft part.

13. A function carrier in accordance with claim 1, wherein said shaft part has a ring groove in a region directly ahead of said concave fillet and wherein said ring region of said rivet sleeve is adapted to be deformed into said ring groove.

14. A function carrier in accordance with claim 1, wherein said concave fillet is provided with features providing security against rotation and wherein said rivet sleeve is deformable into a form-fitted connection with said features providing security against rotation.

15. A function carrier in accordance with claim 14, wherein said features providing security against rotation comprise at least one of recesses and noses distributed in a peripheral direction around said concave fillet.

16. A function carrier in accordance with claim 1, wherein said head part has an end face remote from said shaft part, said end face being provided with features providing security against rotation.

17. A function in accordance with claim 4, wherein said ring region of said rivet sleeve has, when considered in a radial section, at least substantially the shape of a right-angled triangle, having an outer side which is arranged obliquely to said end face of said rivet sleeve remote from said head part and to an inner face of said rivet sleeve adjacent said shaft part.

18. A function carrier in accordance with claim 1, wherein said tubular deformable region of said rivet sleeve has an inner wall representing an axial continuation of an inner surface of said ring region of said rivet sleeve.

19. A function carrier in accordance with claim 1, wherein said tubular region of said rivet sleeve is at least substantially rectangular when considered in radial section, with said tubular region having an inner wall which represents an axial continuation of an inner surface of said ring-like region of said rivet sleeve and wherein said ring region of said rivet sleeve forms a ring shoulder at its outer side with an adjacent side of said ring region.

20. A function carrier in accordance with claim 1, wherein said function carrier is formed as a bolt element.

21. A function carrier in accordance with claim 1, wherein said function carrier is formed as a nut element.

22. A function carrier in accordance with claim 21, wherein at least said shaft part is made hollow and at least one of said shaft part and/or said head part is formed with an internal thread.

23. A function carrier in accordance with claim 1 in combination with a metal or plastic plate having said first and second sides and said hole, said hole having a marginal region and said marginal region being trapped in said groove.

24. A component assembly in accordance with claim 23, wherein said hole defines a pot-like recess having a base and an end face of said head part remote from said shaft part contacts said base in a manner secured against rotation and a radially outwardly deformed end of said rivet sleeve projecting radially outwardly beyond said head part projects into a sidewall of said pot-like recess.

25. A component assembly in accordance with claim 23, wherein said rivet sleeve has an end face remote from said head part, said end face being arranged on one of said first surface remote from said head part and sunk into said surface.

26. A component assembly in accordance with claim 25, said ring region of said rivet sleeve projecting radially into a groove of said shaft part.

27. A component assembly in accordance with claim 26, wherein said rivet sleeve has a conical alignment aid in a region adjacent said groove, said conical alignment aid being disposed concentric to said shaft part for aligning a component to be mounted on said component assembly.

28. A method of inserting a function carrier comprising a functional element and a rivet sleeve into a metal or plastic plate having a first and a second side and a hole extending from said first side towards said second side, said hole having an internal diameter, said functional element comprising a head part having an external diameter corresponding to said internal diameter, a shaft part having an axial direction and a rounded concave fillet in a transition region between said shaft part and said head part, said rivet sleeve having a tubular deformable region adjacent said head part and a ring region remote from said head part, said ring region having an external diameter greater than said internal diameter, the method comprising the steps of passing said head part from said first side through said hole formed in said plate until said ring region contacts said first side, subsequently moving said rivet sleeve in said axial direction, thereby deforming said tubular deformable region at said concave fillet to deflect said tubular deformable region radially outwardly into an anchoring position in which a free end of said tubular region projects radially beyond said head part, trapping material of said plate in a groove formed between said ring region and said radially outwardly projecting deflected tubular region.

29. A method in accordance with claim 28, wherein the free end of the tubular region is pressed into the hole wall of the component by the deformation of the tubular region of the rivet sleeve and thus prevents the extraction of the function carrier out of the recess of the component receiving the head part of the function carrier.

30. A method in accordance with claim 28, wherein said groove receives material provided at a marginal edge of said hole.

31. A method in accordance with claim 30, wherein said ring region of said rivet sleeve is deformed into a ring groove formed in said shaft part directly ahead of the concave fillet.

32. A method in accordance with claim 28, wherein said rivet sleeve is moved in said axial direction towards said concave fillet while an axial force in an opposite direction is produced on said shaft part of said functional element.

33. A method in accordance with claim 28, wherein said ring region of the rivet sleeve has an internal thread which is screwed onto an external thread provided on the shaft part of the functional element and radial deformation of the tubular region of the rivet sleeve is produced by a relative rotation between said rivet sleeve and said functional element.

34. A method in accordance with claim 28, wherein an auxiliary tool provided with a thrust bearing having first and second rings and rolling elements disposed therebetween is used for the deformation of said rivet sleeve, with said first ring having an end face remote from said rolling elements which presses against an end face of said ring region of said rivet sleeve and said second ring being provided at a rotatable sleeve which has an internal thread which cooperates with an external thread provided on said shaft part of said functional element, with rotation of said rotatable sleeve relative to said external thread of said shaft part of said functional element leading to an axial movement of said thrust bearing and of the rivet sleeve and through this to a deformation of said rivet sleeve at said concave fillet of said functional element.

35. Tool for the insertion of a function carrier comprising a functional element and a rivet sleeve into a metal or plastic plate having a first and a second side and a hole extending from said first side towards said second side, said hole having an internal diameter, said functional element comprising a head part having an external diameter corresponding to said internal diameter, a shaft part having an axial direction and a rounded concave fillet in a transition region between said shaft part and said head part, said rivet sleeve having a tubular deformable region adjacent said head part and a ring region remote from said head part, said ring region having an external diameter greater than said internal diameter and said rivet sleeve being movable in said axial direction along said shaft part and said tubular deformable region over said rounded concave fillet to deform said tubular deformable region radially outwardly to a maximum diameter greater than said external diameter thereby forming a groove between said radially outwardly deformed region and said ring region, wherein said tool has inner and outer coaxial devices rotatable relative to one another, with the inner device being adapted for a rotationally fixed connection to said shaft part of said functional element and said outer device being adapted for a rotationally fixed connection to one of said rivet sleeve and an auxiliary tool which presses onto said rivet sleeve, with one of said ring region of the rivet sleeve and said outer device having an inner thread which cooperates with an outer thread provided on the shaft part of said functional element.

36. A tool in accordance with claim 35, wherein said auxiliary tool is formed as a thrust bearing having rolling elements, said thrust bearing having a first ring with an end face remote from said rolling elements which presses against an end face of said ring region of said rivet sleeve and a second ring provided on a rotatable sleeve having an internal thread which cooperates with an external thread provided on the shaft part of said functional element, with rotation of said rotatable sleeve relative to said external thread of said shaft part of said functional element leading to an axial movement of said thrust bearing and of the rivet sleeve and through this to a deformation of said rivet sleeve at said concave fillet of said functional element.

37. Function carrier in accordance with claim 1, wherein said ring region of the rivet sleeve has noses and/or recesses at a side confronting said plate to provide a security against rotation.

38. A function carrier comprising a functional element and a rivet sleeve, said functional element comprising a head part having an external diameter, a shaft part having an axial direction and a rounded concave fillet in a transition region between said shaft part and said head part, said rivet sleeve having a tubular deformable region adjacent said head part and a ring region remote from said head part, said ring region having an external diameter substantially greater than said external diameter and said rivet sleeve being movable in said axial direction along said shaft part and said tubular deformable region over said rounded concave fillet to deform said tubular deformable region radially outwardly to a maximum diameter greater than said external diameter thereby forming a groove between said radially outwardly deformed region and said ring region.
